(19) United States
(12) Patent Application Publication
(10) Pub. No.: US 2005/0120124 A1
(43) Pub. Date: Jun. 2, 2005

(54) Streaming of media from a server to a client device

(75) Inventor: Jari Tapani Korhonen, Singapore (SG)

Correspondence Address: Ware. Fressola, Van Der Sluys & Adolphson, LLP;Bradford Green, 755 Main Street, Building 5, P.O. Box 224, Monroe, CT, 06468, US

(73) Assignee: Nokia Corporation

(21) Appl. No.: 10/934,796

(22) Filed: Sep. 3, 2004

(30) Foreign Application Priority Data
Sep. 4, 2003 (FI) 20031260

(51) Int. Cl. G06F 15/16; H04L 1/00; G06F 11/00

(52) U.S. Cl. 709/231; 709/203; 714/746

(57) ABSTRACT

The invention relates to a method for streaming of media, in which method streaming media is transmitted from a server (111) through a network (102-104) to a client device (101, 101′) for reproduction, and wherein transmission of streaming media is implemented by using a layered protocol stack having an application layer, a transport layer and other protocol layers. The transport layer comprises an error checking mechanism, with which the transport layer detects transmission errors in the transmission of streaming media. In the method the application layer controls the error checking mechanism of the transport layer and the application layer determines the situation in the network (102-104) as regards transmission errors by means of controlling the error checking mechanism of the transport layer. In the method the application layer carries out a streaming adaptation step in order to adapt transmission of streaming media to the determined situation in the network (102-104).

### CROSS-REFERENCE TO RELATED APPLICATION

This application claims priority under 35 USC §119 to Finnish Patent Application No. 20031260 filed on Sep. 4, 2003.

### FIELD OF THE INVENTION

The invention relates to streaming of media, wherein streaming media is transmitted from a server through a network to a client device for reproduction and wherein the transmission of streaming media is implemented by using a layered protocol stack.

### BACKGROUND OF THE INVENTION

Multimedia streaming is a session-based unidirectional service. Therein one or more media components, such as speech, audio, video, text, graphics or the like, can be streamed or transmitted otherwise nearly in real time from a streaming server to a streaming client device for reproduction. Hereinafter in this specification the streaming server is simply called by the name of server, while the streaming client device is called by the name of client device. The transmission route from the server to the client device may be implemented with the aid of a wire-line network and/or a wireless network. Typically more than one client device may access the server through the network. The client device may make requests to the server, to which the server will then respond.

One of the server's duties is to transmit to the client device the media flow, which it has requested. Upon reception of the media, the client device immediately reproduces the media or does so with a short delay. This means that the media reproduction need not be downloaded in its entirety before the reproduction can begin. Hereby the client device need not store the entire media contents all at once, which will save memory capacity. The media contents to be transmitted (or streamed) may be pre-recorded or alternatively it may be transmitted during a media event (for example, a concert) to one or more client devices as a live transmission or a live broadcast.

In the following are some examples of streaming services:
Audio streaming (audio streaming, for example, a piece of music, is offered to the client device)
Streaming with an audio or video component (newscasts, music videos, film ads etc.)
Audio streaming with a simultaneous visual performance, which comprises still frames, text and/or graphic animations and/or video cut-outs shown in a predetermined order.

FIG. 1 shows a communication system known in the state of the art. The system comprises a server 111, which is connected to a fixed network 104. The fixed network may 104 be an TIP (Internet Protocol) network, such as the Internet, or an Intra net network of a service provider-operator (an Intra net network belonging to the operator's domain). The fixed network 104 of FIG. 1 is connected to the core network 103 of a mobile communication network. The connection may be, for example, through a GI interface. The mobile communication network may be, for example, a GAPS or EGGS (General Packet Radio Service, Enhanced GAPS) network of the 2.5^{th} generation, or a cellular radio network of the third generation or of some later generation.

The mobile communication network comprises a radio access network (RAN) 102 connected to the core network 103. The radio access network 102 provides the client device 101 with access to the mobile communication network by way of one or more base transitive stations (not shown) of the access network. Between the radio access network 102 and the client device 101 there is an air interface (or a radio interface). The packets of the media flow are carried over the air interface typically either with the aid of circuit-switched means (for example, a circuit-switched data call) or with the aid of packet-switched means (for example, GAPS).

Alternatively, the client device may be in a direct connection with the fixed network 104 and this way with the server 111, such as the client device 101′ in FIG. 1.

Many streaming applications have conflicting demands on the streaming transmission: the media content is often transmitted in real time, which exposes the transmission to errors and limits the possibility of retransmission and buffering of lost packets for repairing and prevention of error situations; on the other hand, however, streaming applications require that the transmission should be of a relatively high quality, so that the media content can be reproduced without any errors disturbing the user. For this reason, the streaming system ought to be able to adapt to changing circumstances in the communication network. In traditional fixed TIP networks, packet losses are typically caused by congestion in the network, whereby the optimum strategy may be slowing down the transmission rate as the number of packet losses increases. On the other hand, in wireless networks, packet losses are typically caused by physical transmission errors (for example, bit errors). In this case, the optimum strategy for remedying packet losses could be, for example, re-transmission of the lost packets.

When a higher-level protocol, such as, for example, RTP (Real-time Transport Protocol) is used in streaming in connection with heterogeneous networks, the transmitting and receiving streaming applications (which are located on top of the protocol stack) do not know whether the disappearance of packets takes place in the fixed part or in the wireless part of the network. It would be important to know this when choosing a suitable transmission technique for streaming.

The published US patent application US 2003/0067872 A1 presents a way in which the final user may detect congestion in the network, but this publication does not, for example, divide the network into a fixed part and a wireless part.

Known in the art are also proposals for solving the problem of, for example, how to make the TCP protocol (Transmission Control Protocol) better suitable for wireless connections. However, these solutions are typically based on the assumption that it is already known beforehand whether the bottleneck of the network is in the fixed part or in the wireless part of the network.

### SUMMARY OF THE INVENTION

An invention has now been made, with the aid of which the application layer can be provided with more exact information about the situation more easily than is possible with the traditional methods. Hereby the application can adapt its streaming transmission more accurately taking into account the changing conditions in the network.

According to a first aspect of the invention, a method is implemented for streaming of media, the method comprising:
transferring streaming media from a server through a network to a client device for reproduction, and wherein the transfer of streaming media is carried out using a layered protocol stack having an application layer, a transport layer and other protocol layers, and which transport layer comprises an error-checking mechanism with which the transport layer detects transmission errors in the transmission of streaming media.

It is characteristic of the method, that in the method:
the application layer controls said error-checking mechanism of the transport layer;
the application layer determines the situation of the network as regards transmission errors by means of controlling the error-checking mechanism of the transport layer; and
the application layer carries out the adaptation step of streaming in order to adapt the transmission of streaming media to the determined situation of the network.

Transmission errors may be, for example, packet losses and bit errors. Since in the embodiments of the invention the application layer itself collects information on the situation of the network, such as the bit error and/or packet loss situation, there is no need for any separate data transmission mechanism through the protocol stack in order to transmit this data from the protocol layers.

In one embodiment of the invention, the error-checking mechanism of the transport layer, such as the checksum, is controlled by turning off the error-checking mechanism of the transport layer in order to form unprotected packets and by turning on the error-checking mechanism of the transport layer in order to form protected packets for transmission. The network situation may be determined, for example, based on the reception ratio of unprotected and protected packets. In particular, if the network comprises both a wire-line and a wireless part, one embodiment of the invention makes it possible to find out whether packet losses are caused mainly by events in the wire-line part or in the wireless part of the network.

In one embodiment of the invention, the error-checking mechanism of the transport layer is turned partly on or partly off, whereby the error checking of the transport layer will concern only a part of the payload part of the packet to be transmitted.

In one embodiment of the invention, the distribution of bit errors describing the network situation is determined by using application layer checksum, such as CRC (Cyclic Redundancy Check).

In one more embodiment of the invention, statistics are maintained on bit and/or packet errors in the client device and information about these is delivered to the server's streaming application in a feedback message. The server may adapt its streaming transmission in accordance with the contents of the feedback messages.

According to a second aspect of the invention, a server is implemented which is adapted to transmit streaming media through a network to client device for reproduction, and which server comprises:
for transmission of streaming media, a layered protocol stack having an application layer, a transport layer and other protocol layers, and which transport layer comprises:
an error checking mechanism, with which the transport layer detects transmission errors in the transmission of the streaming media, wherein the application layer of the server comprises:
means for controlling said error checking mechanism of the transport layer, whereby the situation in the network can be determined as regards transmission errors from the application layer by means of controlling the error checking mechanism of the transport layer; and
means for carrying out a streaming adaptation step in order to adapt the transmission of streaming media to the determined situation in the network.

According to a third aspect of the invention, a client device is implemented which is adapted to receive for reproduction streaming media transmitted from a server through a network, and which client device comprises:
for transmission of streaming media a layered protocol stack having an application layer, a transport layer and other protocol layers, and which transport layer comprises:
an error checking mechanism, with which the transport layer detects transmission errors in the transmission of streaming media, wherein the application layer of the client device comprises:
means for determination of the situation in the network as regards transmission errors by using a transmission arrived from the server, for the transmission of which the server's application layer has used controlling the error checking mechanism of the transport layer; and
means for transmitting information concerning the determined situation in the network to the server, whereby the server can carry out a streaming adaptation step in order to adapt the transmission of streaming media to the determined situation in the network.

In one embodiment of the invention, the client device is a wireless communication device or it comprises a wireless communication device.

According to a fourth aspect of the invention, a system is implemented which system comprises:
means for transmitting streaming media from a server through a network to a client device for reproduction, and wherein the transmission of streaming media is implemented by using a layered protocol stack having an application layer, a transport layer and other protocol layers, and which transport layer comprises an error checking mechanism, with which the transport layer detects transmission errors in the transmission of streaming media, wherein the system comprises:
means for controlling said error checking mechanism of the transport layer from the application layer;
means for determination of the situation in the network (102-104) as regards transmission errors by the application layer by means of controlling the error checking mechanism of the transport layer; and
means for carrying out a streaming adaptation step by the application layer in order to adapt the transmission of streaming media to the determined situation in the network.

According to a fifth aspect of the invention, a software application executable in a server is implemented which server is adapted to transmit streaming media through a network to a client device for reproduction, and which software application comprises:
program code for implementation of a layered protocol stack for transmission of streaming media, which protocol stack has an application layer, a transport layer and other protocol layers, and which transport layer comprises:
an error checking mechanism, with which the transport layer detects transmission errors in the transmission of streaming media, wherein the software application comprises:
program code for controlling said error checking mechanism of the transport layer, whereby the application layer can determine the situation in the network as regards transmission errors by means of controlling the error checking mechanism of the transport layer; and
program code for carrying out a streaming adaptation step in order to adapt the transmission of streaming media to the determined situation in the network.

According to a sixth aspect of the invention, the software application executable in a client device is implemented which client device is adapted to receive for reproduction streaming media transmitted through a network from a server, and which software application comprises:
a layered protocol stack for transmission of streaming media, which protocol stack has an application layer, a transport layer and other protocol layers, and which transport layer comprises:
an error checking mechanism, with which the transport layer detects transmission errors in the transmission of streaming media, wherein the software application comprises:
program code for determining the situation in the network as regards transmission errors by using a transmission arrived from the server, in the transmission of which the server's application layer has used controlling the error checking mechanism of the transport layer; and
program code for transmitting information concerning the determined situation in the network to the server, whereby the server can carry out a streaming adaptation step in order to adapt the transmission of streaming media to the situation determined in the network.

According to one more aspect of the invention, a method for streaming of media is implemented, wherein the streaming media is transmitted from a server through a network to a client device for reproduction, using a layered protocol stack, in which method:
an application placed on the protocol stack collects information itself from the network in order to determine the situation of the network as regards transmission errors, and the method further comprising:
carrying out in the application layer a streaming adaptation step in order to adapt the transmission of streaming media to the determined situation of the network.

A server, a client device, a system and software applications can be implemented respectively.

The dependent claims concern embodiments of the invention. The contents of dependent claims relating to one aspect of the invention can also be applied to the other aspects of the invention.

### BRIEF PRESENTATION OF THE FIGURES

The invention will be described in detail with the aid of examples and by referring to the appended drawings, wherein

FIG. 1 shows a communication system suitable for streaming service;

FIG. 2 shows a protocol stack in one embodiment of the invention;

FIG. 3 shows a packet in one embodiment of the invention;

FIG. 4 is a flow chart relating to operation in accordance with one embodiment of the invention;

FIG. 5 is a logical block diagram illustrating the functionality of a server in embodiments of the invention;

FIG. 6 is a logical block diagram illustrating the functionality of a client device in embodiments of the invention;

FIG. 7 is a block diagram of the hardware side of a server; and

FIG. 8 is a block diagram of the hardware side of a client device.

### DETAILED SPECIFICATION

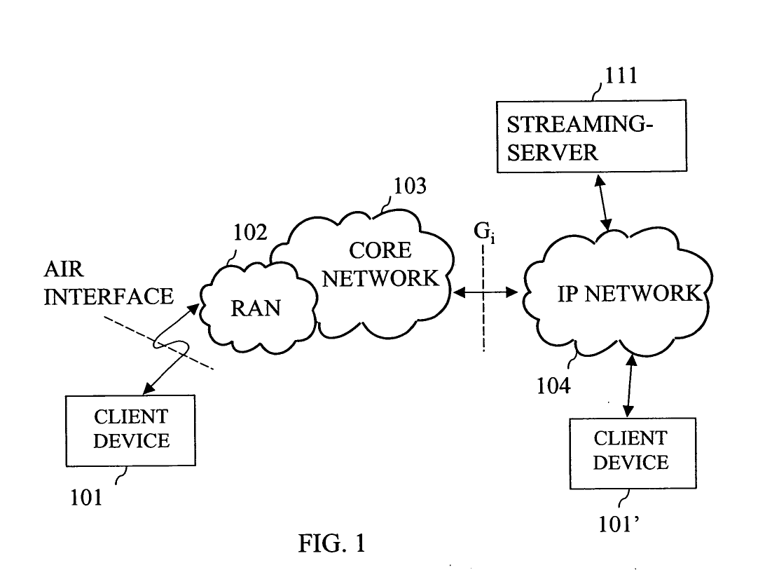

In the description of embodiments of the invention, reference is made to the communication system shown in FIG. 1 and to the specification presented above.

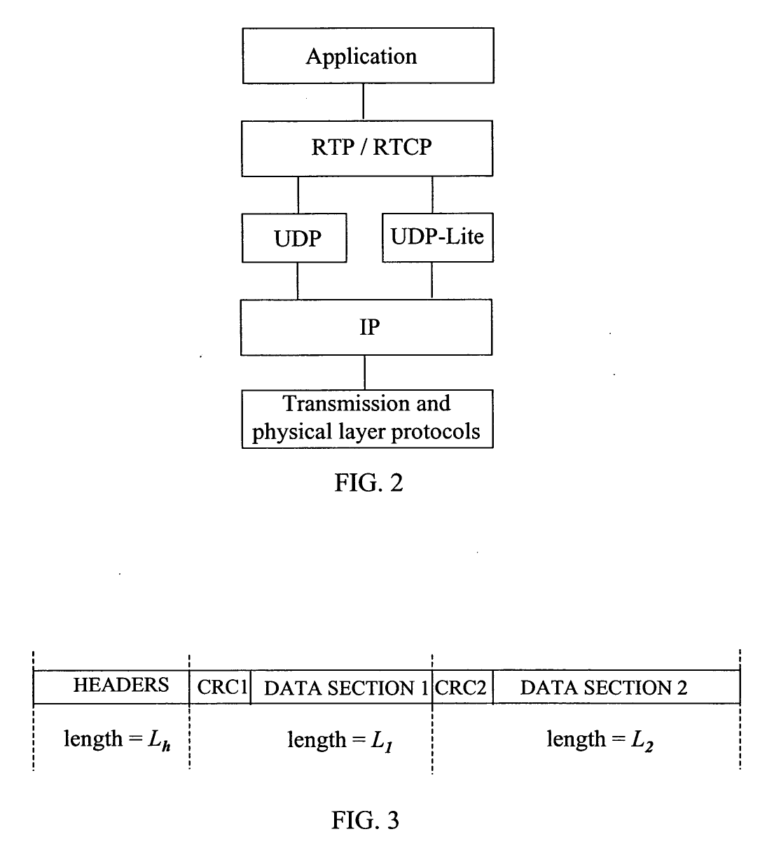

In the embodiments of the invention, communication between the server 111 and the client device 101 is implemented by using a layered protocol stack. FIG. 2 shows an example of a protocol stack and its layers, which are suitable for the purpose. The streaming software applications of the server 111 and client device 101 are situated in the application layer. In the case shown as an example in FIG. 2, payload of the media contents to be streamed is carried by using RTP (Real-time Transport Protocol) on top of UDP (User Datagram Protocol) or UDP-Lite, its modification. In the protocol stack, RTP is situated under the application layer. RTCP (RTP control Protocol) is RTP's control protocol. It is an integrated part of RTP and it is used for forming feedback data and statistical information relating to streaming transmissions. UDP and UDP-Lite are transport layer protocols. They are so-called “unreliable” protocols, which in this context means that in themselves they are unable to guarantee the arrival of packets to their destination by re-transmissions. In the case shown in FIG. 2, UDP and UDP-Lite are situated on top of the TIP (Internet Protocol) layer. Under the TIP layer there are even lower protocol layers, such as transmission layer and physical layer.

Such an error check is known in the art, wherein the server's UDP layer (generally the transport layer) at the transmitting end sets a UDP checksum in the packets to be transmitted in order to detect bit errors. At the receiving end, the UDP layer of the client device checks the checksum and rejects all those packets, which contain bit errors according to the check. The packets containing bit errors do not hereby reach the client device's application, in other words, a packet loss takes place.

An error check of this kind can be removed either entirely or partly. For example, the UDP-Lite protocol allows the use of partial check summing and also entire removal of the checksumming. The faulty packets do not hereby remain in the protocol layer, but they go all the way to the application (on the condition that the error-checking mechanisms of a lower protocol layer, such as the transmission layer, have not already rejected the packets).

In one embodiment of the invention, packets are transmitted both with the error check turned on and turned off, and according to the findings, conclusions are drawn as to whether the main reason for the loss of packets is damage to the packets on the radio path (bit error-based packet losses) or congestion of the network (typically packet losses caused by overflows of routers in fixed network). This information is utilised in choosing the optimum transmission technique for streaming. Unprotected packets is a term used herein as meaning such packets, where the payload error check is not on in protocol layers under the application layer, especially in the transport layer (compare with the OSI model of ISO) (thus, there is no UDP checksum, for example, in unprotected packets). Protected packets again herein signify such packets, which have an error check (for example, the UDP checksum). Hereby it is possible in the transmission of protected packets to use the UDP protocol and in the transmission of unprotected packets to use the UDP-Lite protocol. The client device's streaming application finds out if a packet is lost, for example, by observing the consecutive numbers of the packets it receives. The server's streaming application places a consecutive number on each packet it transmits. If in the flow of received packets a certain consecutive number fails to turn up, then the client device will know that the packet in question is lost. If the number of both protected packets and unprotected packets is equal, the conclusion may be drawn that the loss of packets is mainly due to congestion in the network. On the other hand, if more protected packets are lost than unprotected packets, the conclusion may be drawn that the losses of packets are mainly due to bit errors. When the main reason for the loss of packets is known, the server's streaming application will adapt its transmission taking this information into account. Various alternatives for adapting the transmission will be presented later in this specification.

In the embodiment presented above, the transmission of unprotected packets and protected packets may be implemented, for example, in such a way that the server's streaming application controls the error-checking mechanism (for example, the checksum) of the transport layer (for example, UDP or UDP-Lite) through the programming interface provided by the operating system. For forming unprotected packets, the server's streaming application turns the error-checking mechanism off through the programming interface, and for forming protected packets the server's streaming application turns the error-checking mechanism on through the programming interface. Correspondingly, at the receiving end the client device's streaming application receives information about the use of protection through the programming interface. Alternatively, the streaming application at the transmitting end may, for example, add such a character bit to the payload of the packet to be transmitted, whose value will tell the streaming application at the receiving end whether the packet is unprotected or protected.

For the sake of clarity it was understood in the foregoing embodiment that only such packets are transmitted, wherein the transport layer's error check is on or entirely off. In another embodiment of the invention, however, it is possible by using, for example, the UDP-Lite protocol to transmit such packets, wherein the transport layer's error check is partly on (or partly off) and based on the received packets to draw conclusions of a corresponding kind regarding the state of the network as those presented in the previous embodiment. The circumstance that the transport layer's error check is partly on here means that, for example, when UDP-Lite is in question, then the UDP checksum is set to concern only a part of the packet's payload.

In another embodiment of the invention it is possible to get exact information especially on the distribution of bit errors. In this embodiment, the error-checking mechanism is used in the application layer and it is assumed that the probability of occurrence of bit errors (in a wireless network) follows the following model:
P(l)=1−c·e^{-λl}

wherein P(l) is the probability of occurrence with which a bit error occurs during a travel of a data area of length l in the packet. The parameter c relates to the bit error rate. In more exact words, the parameter c presents a rough estimate of the number of errorless bits. If, for example, every hundredth bit is faulty, then parameter c gets a value of approximately 0.99. Parameter λ is a parameter describing the bit error burst density. When the probability of the beginning of occurrence of bit error bursts is Poisson-distributed, the average bit number between each error burst is 1/λ.

In this embodiment, the checksum of the UDP layer is turned entirely off (or the UDP-Lite protocol is used) and only the application layer's error detection method is used. Thus, here it is not necessary to transmit protected packets at all, but it will suffice to transmit unprotected packets. Bit errors are detected by a suitable error detection method of the application layer. They are detected, for example, by adding an application layer checksum, such as CRC (Cyclic Redundancy Check) to the unprotected packets and by checking it at the receiving end in the received packets. Thus, in this case, even faulty packets arrive at the application layer and it is up to the application what it will do with the data containing bit errors. Some multimedia codecs are able to decode data containing a reasonable amount of bit errors. Otherwise the application does not take the faulty data into account. The packets, to which the application layer checksum is added, may be special test packets or packets containing payload of a streaming transmission.

FIG. 3 shows a packet (or a datagram) including a header part and a payload part. Its payload part is divided into two (may also be divided into more) sections of different lengths (sections 1 and 2, lengths L₁ and L₂ respectively). In the case shown in FIG. 3, any occurrence of bit errors in sections 1 and 2 can be detected independently by checksums CRC1 and CRC2 respectively, which are placed in each section. When the lengths L₁ and L₂ and occurrence of bit errors in sections 1 and 2 are known, the parameters c and λ indicating the distribution of bit errors can be solved in the client device and transmitted to the server. Thus, in order to solve the parameters c and λ one must know the probability of occurrence of bit errors in a packet or part of a packet of a certain size. To solve the parameters, it is not hereby necessary to divide the payload into two sections of different size, but another alternative is, for example, to transmit short and long packets (=clearly of different length), which are in one part (and in each of which there is only one checksum in the application layer) and to determine separately the probability of occurrence of bit errors for the packets of different length.

The streaming application of the server can now adapt its transmission taking into account the distribution of bit errors. In its adaptation of the streaming transmission, the server may take into account, besides the distribution of bit errors, also the collected packet loss information (the collecting is presented in the earlier embodiments), whereby a better precision is achieved in the adaptation of streaming. However, this is not obligatory, but the different embodiments of the invention may alternatively be thought of as being independent of one another. Different alternatives for adapting the transmission will be presented later in this specification.

The transmitting application sets consecutive numbers in the packets to be transmitted and also provides them with time stamps, based on which the receiving client device may collect both the information presented above and also information on the transit times of packets and on any jitter therein. This information can also be used in the adaptation of the streaming to the network conditions.

Thus, in the ways presented above relatively accurate information is obtained on the distribution of bit errors (typically a characteristic of a wireless connection) and on packet losses (characteristic both of fixed and wireless networks) and on packet transmission times and on transmission time jitter. The information available can be taken into account in making decisions to choose different ways of action to adapt the streaming transmission to network conditions. The more information there is available, the more accurate is the choice of different steps. Different alternatives are presented by way of example in the following:
Case A: Protected packets and unprotected packets disappear in essentially equal numbers.
   Diagnosis: The packet losses are primarily due to congestion.
   The proposed strategy is slowing down the transmission rate. This may be done, for example, by exchanging a bit flow to be transmitted for another, which is coded for a lower bit rate.
Case B: Protected packets disappear in essentially higher numbers than unprotected packets.
   Diagnosis: The packet losses are primarily due to bit errors.
   The proposed strategy is using small packets in the transmission, (selective) re-transmissions of packets (only the most important packets are re-transmitted) or adding of redundancy to unprotected packets (that is, using FEC, Forward Error Correction).
Case C: Low packet loss frequency both for protected packets and unprotected packets, but a great variation in the transmission times for big packets and less variation in the transmission times of small packets.
   Diagnosis: Wireless network would seem to use re-transmissions of damaged packets in the transmission layer (below the transport layer in the protocol stack).
   The proposed strategy is using a small packet size to reduce the variation of transmission times and to reduce the probability of congestion (due to the expectation of wearing out of timers) in the wireless network.

If information is available on the distribution of bit errors, it is also possible in case B to make the choice of the optimum adaptation step (or transmission technique) more accurate:
Sub-case B1: Essentially more protected packets disappear than unprotected packets. In addition, brief high-frequency error bursts occur (a high parameter λ value).
   The proposed strategy is using unprotected packets, adding redundancy to these (that is, to use FEC) or using partial re-transmissions (only the damaged part of a packet is re-transmitted, that is, the packet is divided by the different application level checksums into parts and when it is seen in which part the bit errors are, the streaming application of the client device requests only re-transmission of this part of the packet).
Sub-case B2: Essentially more protected packets disappear than unprotected packets. In addition, long low-frequency error bursts occur (a low parameter λ value).
   The proposed strategy is using protected packets and (selective) re-transmissions.

The coding method for use in the server may set limits to the number of available streaming adaptation steps. For example, in connection with the control of packet size (cases B and C), some encoding methods are more flexible than others. Certain date encoding and packet-making methods support a relatively flexible packet size control, as is presented in the publication: J. Korhonen: Robust Audio Streaming over Lossy Packet-Switched Networks. In the Proceedings of ICOIN-03, 12-14 Feb. 2003, Jeju Island, Korea, pp. 1343-1352. The steps presented above in connection with packet size control may thus be used, for example, in connection with the system presented in the publication. Streaming adaptation steps in accordance with the different embodiments of the invention can well be applied also to such a system where layered encoding is used. In layered encoding, a higher priority (that is, for example, a smaller packet size and more selective re-transmission attempts) may be given to the data of a basic layer and a lower priority may be given to the data of another layer (the enhancement layer).

In the embodiments of the invention, the client device collects information on packet losses and on bit errors, as was told in the foregoing. By using suitable mathematical functions (for example, averaging) the software of the client device can constantly calculate and keep up short-term and long-term parameters depicting packet loss frequencies and the distribution of bit errors. For example, in order to calculate the average probability of packet losses, the client device (or the client device's application) may apply the formula PER=0.8PER_{ed}+0.2(LOST/TOT), wherein PER is the averaged probability of packet losses, PER_{ed} is the previous value of probability of packet losses, LOST is the number of lost packets and TOT is the total number of packets after the last PER value update. This information is transmitted regularly in feedback messages to the server or, in the event of an especially quick change, earlier than otherwise. For the transmission of feedbacks it is possible to use, for example, RTCP feedbacks (a special application-specific feedback packet, APP, is defined in the RTCP) or, alternatively, an own application layer protocol may be defined for the feedback messages.

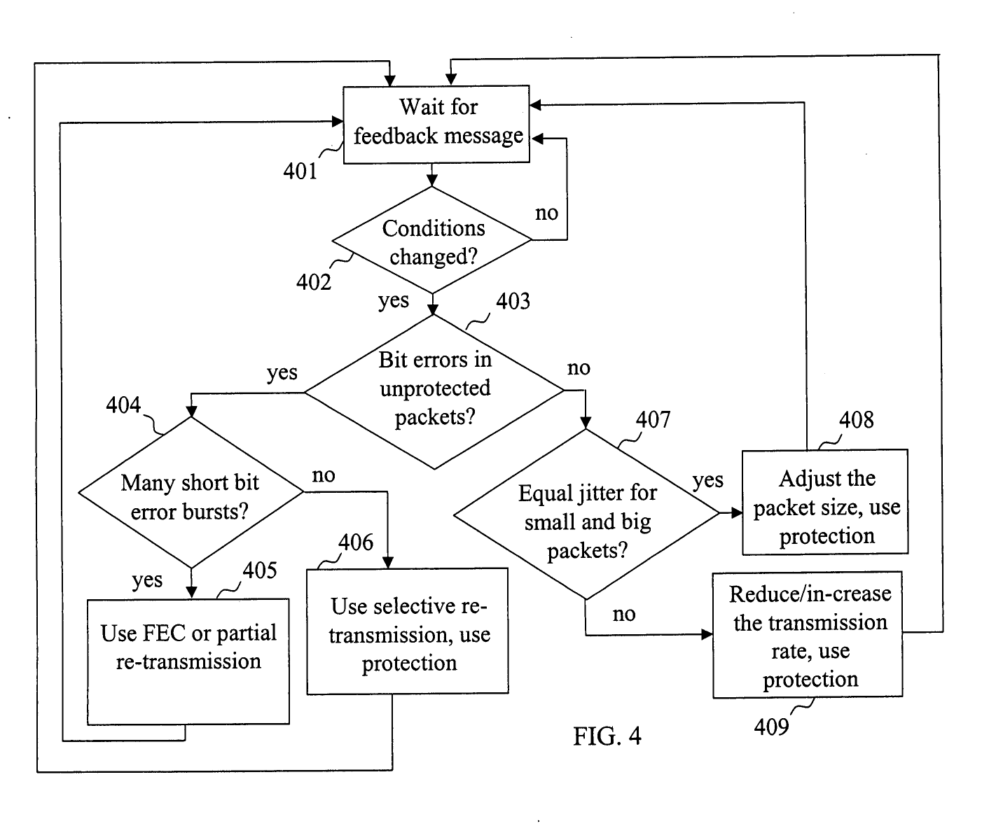

The server makes the required changes in order to adapt the streaming transmission to network conditions based on the contents of feedback messages. It is possible, for example, to set threshold values for each combination of parameters or to use fuzzy logic to combine parameters for an optimum solution. FIG. 4 shows a flow chart illustrating how changes can be made in the transmission mode, according to one embodiment of the invention.

In block 401, the server is waiting for a feedback message from the client device. When the feedback message arrives, the next step is in block 402. If the feedback message indicates that the conditions have changed, the next step is in block 403. Otherwise the next step is to wait for a new feedback message in block 401. Based on the feedback message, a check is made in block 403 to find out if bit errors have been observed in unprotected packets.

If bit errors have been observed in unprotected packets, the next step is in block 404. Based on the feedback message, a check is made in block 404 to find out if many short bit error bursts have occurred. If many short bit error bursts have occurred, the server's software application may as an adaptation step begin, for example, adding redundancies to the packets or using partial re-transmissions (block 405). If many short bit error bursts have not occurred, the server's software application may as an adaptation step begin using selective re-transmissions and protected transmissions (block 406).

If bit errors have not been observed in unprotected packets, the next step is in block 407. Based on the feedback message, a check is made in block 407 to find out whether the transmission time jitter of packets is essentially the same for small and big packets. If it is the same, the server's software application may as an adaptation step adjust the packet size (if the packet size has no effect on the transmission time jitter, it is usually more advantageous to use a big packet size) and begin using protected transmissions (block 408). If it is not the same, the server's software application may as an adaptation step slow down or increase the transmission rate (if, for example, the transmission rate has been lowered earlier and the conditions have now improved (that is, the jitter is now within the permissible limits), the transmission rate may be increased; if the jitter is excessive, it is possible to use a smaller packet size but a higher packet transmission rate; but if the jitter is small, it is possible to use a bigger packet size but a lower packet transmission rate) and begin using protected transmissions (block 409).

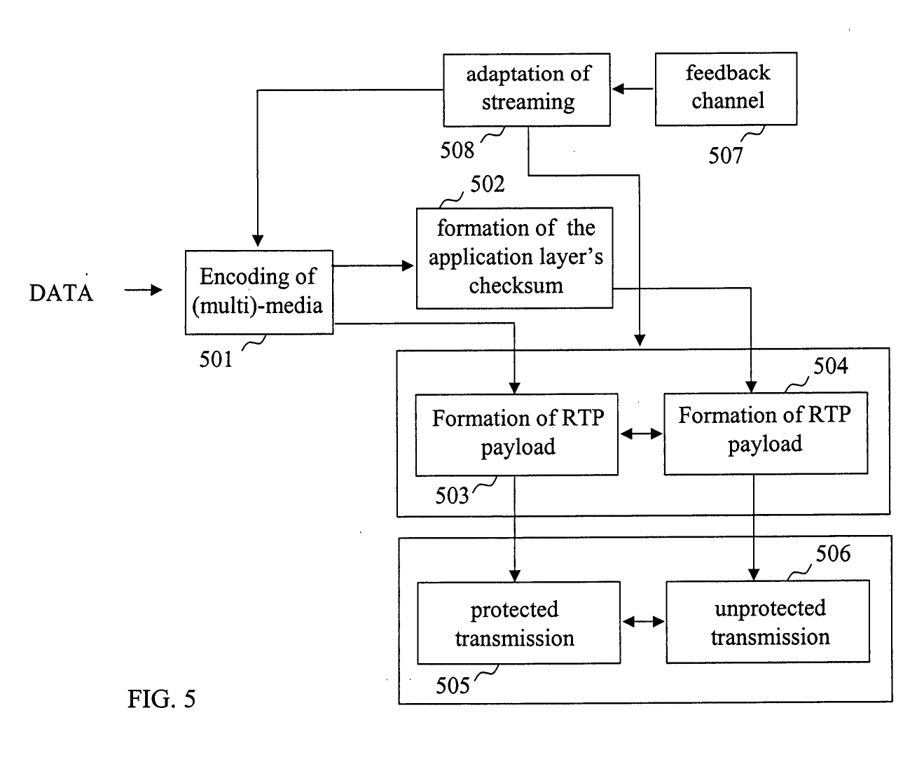

The simplified logical block diagram in FIG. 5 illustrates the functionality of the server 111. (Multi)media data is encoded in block 501. The encoded data (or payload) is directed to payload formation in the RTP layer (blocks 503 and 504). In the embodiments of the invention, an application layer checksum may be added to the payload in block 502 before formation of the RTP payload. The formed RTP payload, which may or may not contain the application layer checksum, is directed to the lower protocol layers either for a protected or an unprotected transmission (blocks 505 and 506). In a protected transmission, a protocol layer checksum is also added to the packet to be transmitted (here: a UDP checksum). This is not done in the unprotected transmission. Block 508 adapts the streaming to network conditions by controlling the media encoding (block 501), the formation of the RTP payload (blocks 503 and 504) and/or the transmission of packets (blocks 505 and 506) based on the contents of feedback messages received from feedback channel 507.

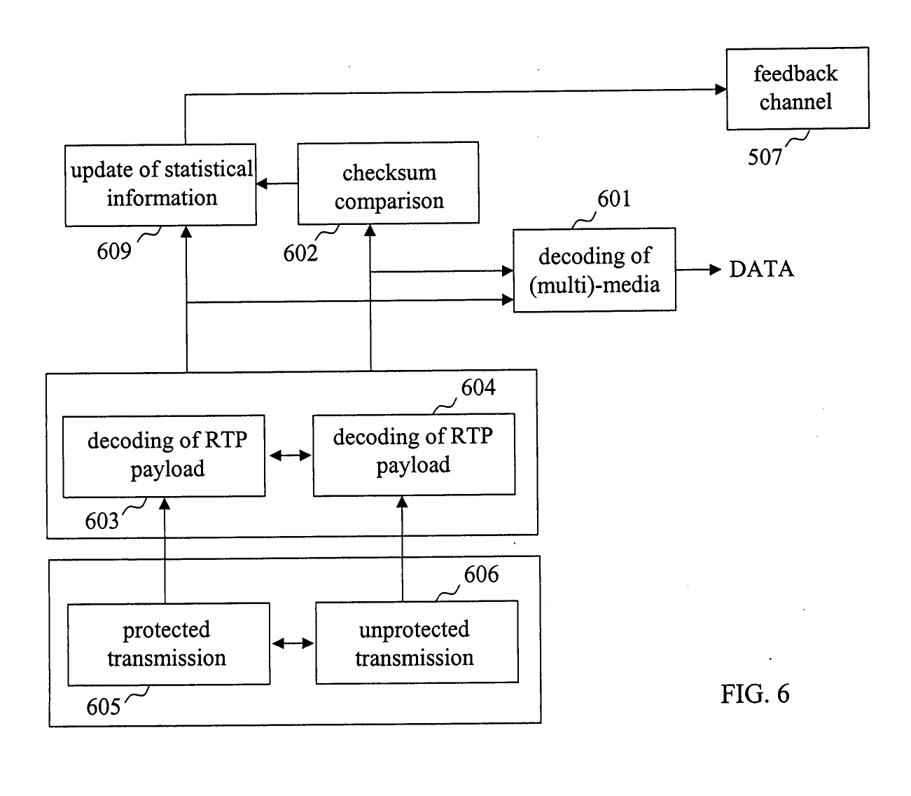

The simplified logical block diagram in FIG. 6 illustrates the functionality of the client device 101. A protected transmission and an unprotected transmission are received in blocks 605 and 606 respectively. As regards the protected transmission, the protocol layer checksum (here: the UDP checksum) is checked in block 605. If the sum does not match, the packet is rejected. The RTP payload is decoded in blocks 603 and 604. In block 601, the payload is decoded to form the original (multi)media data. If the payload contains an application layer checksum, then this is checked in block 602. Based on the checksum and the received transmissions, statistical information is updated in block 601, parameters depicting packet losses and the distribution of bit errors are formed and feedback messages are transmitted to the transmitting server through feedback channel 507.

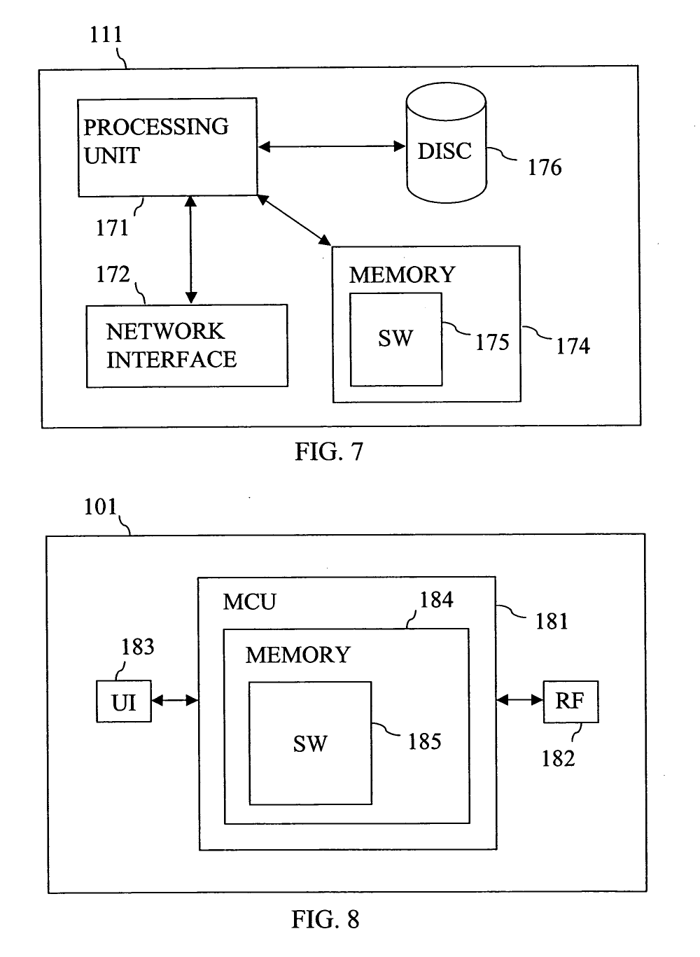

The simplified logical block diagram in FIG. 7 illustrates the server 111 from the viewpoint of hardware implementation. Server 111 comprises a processing unit 171, a network interface 172, a first memory 174 and a second memory 176. The network interface 172 and memories 174 and 176 are connected to the processing unit 171.

Processing unit 171 controls the operation of the server 111 based on software 175 stored in the first memory 174, such as the transmission of media contents stored beforehand in the second memory (disc) 176 through network interface 172 to the client device 101.

Software 175 comprises the server's streaming application (and other software) for implementation of the protocol layers. The software is built up of a set of program codes, which may be packaged into one a computer program block or into different blocks of one computer program or they may be parts of a bigger software assembly.

The application layer checksums mentioned in the embodiments of the invention are added by the streaming application. It also controls the turned-on state of the transport layer's error checking mechanism and receives the feedback messages transmitted by the client device 101 and decides on steps to be taken to adapt the streaming to network conditions.

The simplified logical block diagram in FIG. 8 illustrates the client device 101 from the viewpoint of hardware implementation. Client device of this kind could be, for example, a mobile station, a smart phone or a hand-held computer equipped with a cellular network function or a laptop. The client device 101 in FIG. 8 comprises a processing unit 181, a radio frequency part 182 and a user interface 183. The radio frequency part 182 and the user interface 183 are connected to the processing unit 181. User interface 183 comprises a display, a keyboard and a loudspeaker (not shown), with the aid of which the user can use the client device 101.

Processing unit 181 comprises a processor (not shown) and a memory 184. A client device's software 185, which comprises the streaming application and the other software, is stored in memory 184. By means of these the processor controls the client device's 101 operation, such as the use of radio frequency part 182, the presentation of information on the display of user interface 183 and the reading of inputs arriving through the keyboard of user interface 183. The software is built up of a set of program codes, which may be packaged into one computer program block or into different blocks of one computer program or they may be parts of a bigger software assembly.

In the embodiments of the invention, the client device's software 185 attends to the definition and maintenance of said distribution of bit errors, to the definition of packet losses and to the formation of feedback messages. The feedback messages are transmitted to server 111 through the radio frequency part 182.

By means of the embodiments of the invention it is possible, by transmitting both protected packets and unprotected packets mixed together, to find out whether packet losses are due to, for example, congestion in a router of the fixed network (whereby protection of packets is of no significance to the quantity of packet losses) or to (bit) errors on the radio path of the wireless network (whereby more protected packets are lost than unprotected ones). In a case where bit errors are dominating, it is also possible with a suitable error detection method of the application layer, such as check summing, to determine the distribution of bit errors, so that the server can choose the optimum step to adapt the streaming transmission to existing network conditions.

In the embodiments of the invention, the server's streaming application is able to collect information on the network and on network conditions without any separate data communication mechanism through the protocol stack and to adapt its operation in accordance with the existing conditions. In the embodiments of the invention, means are provided for implementing various mechanisms, which can be used to optimise streaming to be suitable even for very heterogeneous network complexes (combinations of wireless and fixed networks). The transmission speed and the number of re-transmissions to use can be adjusted (or limited) in real-time multimedia communication. In this manner it is possible especially in a radio network to release transmission band resources, and it is possible to reduce the probability of an overflow in radio network buffers or in the routers of a fixed network.

In this specification, the implementation and embodiments of the invention have been presented by means of examples. It is obvious to a man skilled in the art that the invention is not limited to the details of the embodiments presented above and that the invention can also be implemented in another form without departing from the characteristic features of the invention. Thus, the invention must not be bound solely to the composition of the protocol stack now presented, but it can be applied also to other compositions.

The presented embodiments should be regarded as illustrative, but not as limiting. The possible implementations and uses of the invention are only limited by the appended claims. Thus, the various implementation alternatives defined by the claims, also equivalent implementations, belong within the scope of the invention.

1. A method for streaming of media, wherein the method comprises:
transmitting streaming media from a server through a network to a client device for reproduction, and wherein the transmission of streaming media is implemented by using a layered protocol stack having an application layer, a transport layer and other protocol layers, and which transport layer comprises an error checking mechanism, which the transport layer uses to find transmission errors in the transmission of streaming media, wherein the method comprises:
controlling said error checking mechanism of the transport layer from the application layer;
determining, in the application layer, the situation in the network as regards transmission errors by means of controlling the error checking mechanism of the transport layer; and
carrying out, in the application layer, a streaming adaptation step in order to adapt the transmission of streaming media to the determined situation in the network.

2. The method according to claim 1, comprising controlling the error checking mechanism of the transport layer by turning the error checking mechanism of the transport layer off in order to form unprotected packets and by turning the error checking mechanism of the transport layer on in order to form protected packets for transmission.

3. The method according to claim 1, wherein the error checking mechanism of the transport layer is a checksum.

4. The method according to claim 2, wherein the network situation is determined based on the reception ratio of unprotected packets and protected packets.

5. The method according to claim 4, wherein the network comprises both a wire-line part and a wireless part and wherein it is determined whether packet losses are mainly due to events in the wire-line part or in the wireless part of the network.

6. The method according to claim 1, comprising controlling the error checking mechanism of the transport layer by turning the error checking mechanism of the transport layer partly on or partly off, whereby the error checking of the transport layer only concerns a part of the payload part of the packet to be transmitted.

7. The method according to claim 1, comprising transmitting packets, in which the error checking mechanism of the transport layer is turned off and in which an error checking mechanism of the application layer is set.

8. The method according to claim 7, wherein said error checking mechanism of the application layer is a checksum, such as CRC (Cyclic Redundancy Check).

9. The method according to claim 7, comprising using more than one application layer checksum in the same packet or transmitting packets, which packet or transmitting packets are of different lengths and are provided with an application layer checksum, in order to determine the distribution of bit errors.

10. The method according to claim 7, comprising dividing the packet's payload in the application layer into two or more parts of different lengths and applying for each part an own application layer checksum, in order to determine the occurrence of bit errors in the concerned parts respectively.

11. The method according to claim 1, wherein the situation in the network is determined in connection with the distribution of bit errors by using the equation:
P(l)=1−c·e^{-λl},
wherein P(l) is the probability of occurrence of a bit error over a data area of length l in the packet, parameter c is an estimate of the relative number of errorless bits and parameter λ depicts the rate of occurrence of bit error bursts.

12. The method according to claim 1, wherein the streaming adaptation step is in the set of: changing transmission rate, adjusting packet size, use of re-transmissions, use of partial re-transmissions, use of optional re-transmissions, adjusting the use of the error correcting mechanism, such as adding redundancy to the packets, and starting the use of protected and/or unprotected transmissions.

13. The method according to claim 1, comprising maintaining statistics on bit and/or packet errors and delivering information on bit and/or packet errors from the client device to the server in a feedback message.

14. The method according to claim 1, comprising delivering information on bit and/or packet errors from the client device to the server by transmitting feedback messages with an own application layer protocol and/or by an RTCP feedback method (RTP Control Protocol (Real-time Transport Protocol)).

15. A server for streaming of media, which server is adapted to transmit streaming media through a network to client device for reproduction, and which server comprises:
for transmission of streaming media, a layered protocol stack having an application layer, a transport layer and other protocol layers, and which transport layer comprises:
an error checking mechanism, with which the transport layer detects transmission errors in the transmission of the streaming media, wherein the application layer of the server comprises:
means for controlling said error checking mechanism of the transport layer, whereby the situation in the network can be determined as regards transmission errors from the application layer by means of controlling the error checking mechanism of the transport layer; and
means for carrying out a streaming adaptation step in order to adapt the transmission of streaming media to the determined situation in the network.

16. A client device for streaming of media, which client device is adapted to receive for reproduction streaming media transmitted from a server through a network, and which client device comprises:
for transmission of streaming media a layered protocol stack having an application layer, a transport layer and other protocol layers, and which transport layer comprises:
an error checking mechanism, with which the transport layer detects transmission errors in the transmission of streaming media, wherein the application layer of the client device comprises:
means for determination of the situation in the network as regards transmission errors by using a transmission arrived from the server, for the transmission of which the server's application layer has used controlling the error checking mechanism of the transport layer; and
means for transmitting information concerning the determined situation in the network to the server, whereby the server can carry out a streaming adaptation step in order to adapt the transmission of streaming media to the determined situation in the network.

17. A client device according to claim 16, which is a wireless communication device or which comprises a wireless communication device.

18. A system for streaming of media, which system comprises:
means for transmitting streaming media from a server through a network to a client device for reproduction, and wherein the transmission of streaming media is implemented by using a layered protocol stack having an application layer, a transport layer and other protocol layers, and which transport layer comprises an error checking mechanism, with which the transport layer detects transmission errors in the transmission of streaming media, wherein the system comprises:
means for controlling said error checking mechanism of the transport layer from the application layer;
means for determination of the situation in the network (102-104) as regards transmission errors by the application layer by means of controlling the error checking mechanism of the transport layer; and
means for carrying out a streaming adaptation step by the application layer in order to adapt the transmission of streaming media to the determined situation in the network.

19. A software application executable in a server, which server is adapted to transmit streaming media through a network to a client device for reproduction, and which software application comprises:
program code for implementation of a layered protocol stack for transmission of streaming media, which protocol stack has an application layer, a transport layer and other protocol layers, and which transport layer comprises:
an error checking mechanism, with which the transport layer detects transmission errors in the transmission of streaming media, wherein the software application comprises:
program code for controlling said error checking mechanism of the transport layer, whereby the application layer can determine the situation in the network as regards transmission errors by means of controlling the error checking mechanism of the transport layer; and
program code for carrying out a streaming adaptation step in order to adapt the transmission of streaming media to the determined situation in the network.

20. A software application executable in a client device, which client device is adapted to receive for reproduction streaming media transmitted through a network from a server, and which software application comprises:
a layered protocol stack for transmission of streaming media, which protocol stack has an application layer, a transport layer and other protocol layers, and which transport layer comprises:
an error checking mechanism, with which the transport layer detects transmission errors in the transmission of streaming media, wherein the software application comprises:
program code for determining the situation in the network as regards transmission errors by using a transmission arrived from the server, in the transmission of which the server's application layer has used controlling the error checking mechanism of the transport layer; and
program code for transmitting information concerning the determined situation in the network to the server, whereby the server can carry out a streaming adaptation step in order to adapt the transmission of streaming media to the situation determined in the network.

21. The software application according to claim 19 stored on a carrier.

22. The software application according to claim 20 stored on a carrier.

23. A method for streaming of media, wherein the method comprises:
transmitting streaming media from a server through a network to a client device for reproduction, using a layered protocol stack, in which method:
an application placed on the protocol stack itself collects information from the network in order to determine the situation of the network as regards transmission errors, and the method further comprising:
carrying out in the application layer a streaming adaptation step in order to adapt the transmission of streaming media to the determined situation of the network.

24. A server for streaming of media, which server is adapted to transmit streaming media through a network to client device for reproduction, and which server comprises:
for transmission of streaming media, a layered protocol stack, the protocol stack comprising:
an application, which itself collects information from the network in order to determine the situation of the network as regards transmission errors, application layer of the protocol stack comprising:
means for carrying out a streaming adaptation step in order to adapt the transmission of streaming media to the determined situation of the network.

25. A client device for streaming of media, which client device is adapted to receive for reproduction streaming media transmitted from a server through a network, and which client device comprises:
for transmission of streaming media a layered protocol stack, the protocol stack comprising:
an application, which itself collects information from the network in order to determine the situation of the network as regards transmission errors, and
means for transmitting information concerning the determined situation in the network to the server, whereby the server can carry out a streaming adaptation step in order to adapt the transmission of streaming media to the determined situation of the network.

26. A system for streaming of media, which system comprises:
means for transmitting streaming media from a server through a network to a client device for reproduction, and wherein the transmission of streaming media is implemented by using a layered protocol stack, the protocol stack comprising:
an application, which itself collects information from the network in order to determine the situation of the network as regards transmission errors, application layer of the protocol stack comprising:
means for carrying out a streaming adaptation step in order to adapt the transmission of streaming media to the determined situation of the network.

27. A software application executable in a server, which server is adapted to transmit streaming media through a network to a client device for reproduction, and which software application comprises:
program code for implementation of a layered protocol stack for transmission of streaming media,
program code for collecting information from the network in order to determine the situation of the network as regards transmission errors, and
program code for carrying out in the application layer a streaming adaptation step in order to adapt the transmission of streaming media to the determined situation of the network.

28. A software application executable in a client device, which client device is adapted to receive for reproduction streaming media transmitted from a server through a network, and which software application comprises:
program code for implementation of a layered protocol stack for transmission of streaming media,
program code for collecting information from the network in order to determine the situation of the network as regards transmission errors, and
program code for transmitting information concerning the determined situation in the network to the server, whereby the server can carry out a streaming adaptation step in order to adapt the transmission of streaming media to the determined situation of the network.
